(19) United States
(12) Patent Application Publication
(10) Pub. No.: US 2024/0370711 A1
(43) Pub. Date: Nov. 7, 2024

(54) RADAR INPUT FOR LARGE LANGUAGE MODEL

(71) Applicant: Koko Home, Inc., Los Angeles, CA (US)

(72) Inventor: Jens Faenger, Lakewood Ranch, FL (US)

(21) Appl. No.: 18/653,880

(22) Filed: May 2, 2024

Related U.S. Application Data
(60) Provisional application No. 63/463,912, filed on May 4, 2023.

(51) Int. Cl. G06N 3/0475

(52) U.S. Cl. CPC G06N 3/0475

(57) ABSTRACT

In one aspect, a method, includes sensing, with a sensor, a user, extracting information from the sensor, providing a language model with the extracted information upon determining a trigger point has been reached, and generating, with the language model, a response to the extracted information. The sensor may include a radar and the extracted information may include vital signs.

### CROSS REFERENCE TO RELATED APPLICATIONS

This application claims the benefit of priority to U.S. Patent Application No. 63/463,912 filed May 4, 2023, the content of which is incorporated herein by reference in its entirety.

### TECHNICAL FIELD

This disclosure relates to language models and more particularly, but not exclusively, to providing radar input to a language model.

### BACKGROUND

Language models, such as large language models, are artificial neural networks and capable of generating text and other natural language processing tasks such as classification.

### BRIEF SUMMARY

In one aspect, a method, includes sensing, with a sensor, a user, extracting information from the sensor, providing a language model with the extracted information upon determining a trigger point has been reached, and generating, with the language model, a response to the extracted information. The sensor may include a radar and the extracted information may include vital signs.

In one aspect, a non-transitory computer-readable storage medium includes instructions that when executed by a computer, cause the computer to sense, with a sensor, a user, extract information from the sensor, provide a language model with the extracted information upon determining a trigger point has been reached, and generate, with the language model, a response to the extracted information.

In one aspect, a system includes a processor. The system also includes a memory storing instructions that, when executed by the processor, configure the apparatus to sense, with a sensor, a user, extract information from the sensor, provide a language model with the extracted information upon determining a trigger point has been reached, and generate, with the language model, a response to the extracted information.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of an environment in which the present disclosure may be deployed, in accordance with some examples.

FIG. 2 is a diagrammatic representation of a processing environment, in accordance with some examples.

FIG. 3 is a block diagram showing a software architecture within which the present disclosure may be implemented, according to some examples.

FIG. 4 is a diagrammatic representation of a machine in the form of a computer system within which a set of instructions may be executed for causing the machine to perform any one or more of the methodologies discussed herein, in accordance with some examples.

FIG. 5 illustrates training and use of a machine-learning model, according to some example embodiments.

FIG. 6 illustrates a method, according to some example embodiments.

### DETAILED DESCRIPTION

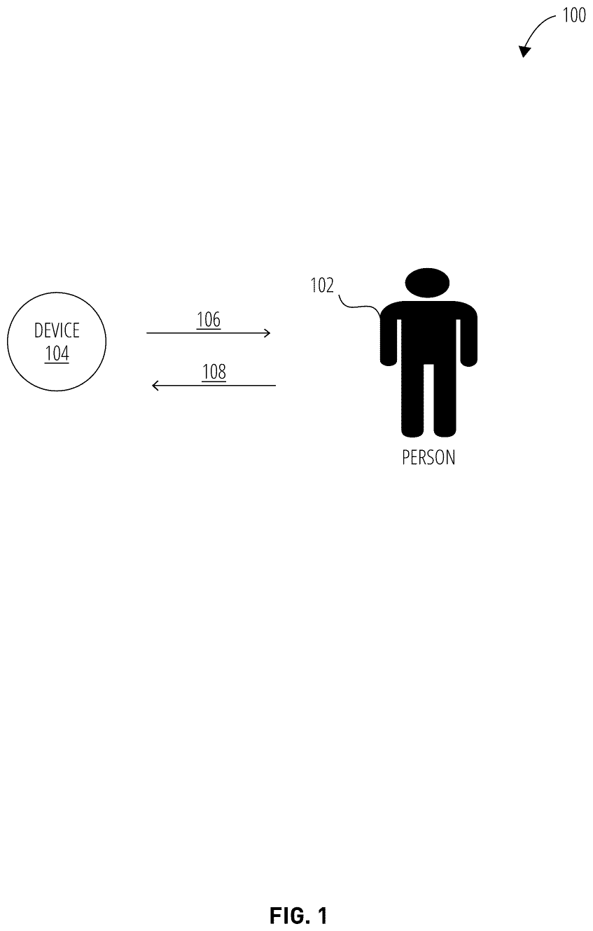

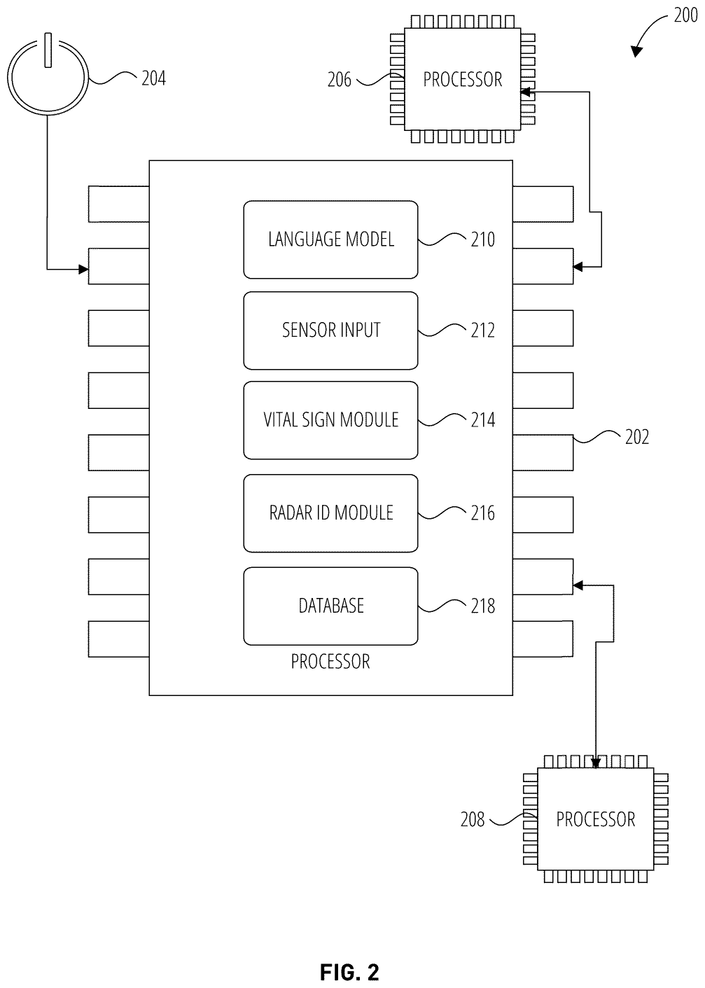

FIG. 1 is a diagrammatic representation of an environment 100 in which the present disclosure may be deployed, in accordance with some examples. A device 104 emits a radiofrequency signal radiofrequency signal 106 towards a person 102 (also referred to as user). The device 104 then receives a backscattered signal 108 and processes it to generate a vital sign that can be fed into a generative artificial intelligence, such as a language model 210 (FIG. 2). The device 104 may be a mmWave radar or other short wave or indoor radar system. The language model can then generate output (e.g., conversation) based on the vital sign and/or other data.

In an example, the device 104 includes any device with sensors, such as radar, microphone, passive infrared motion sensor, camera, temperature, and/or light sensor. It may have a speaker for output (and possibly display, LEDs for interacting with a user, etc.).

In an example, the device 104 senses user presence; extracts context information from sensors; load user context information; decides and waits for trigger point for interaction; processes user input if user started interaction; produces input to a language model; generates response with language model; actuates other devices if needed; generates output (e.g., audio, visual, haptic, etc.) based on the generated response; and stores current context information and conversation

Turning now to FIG. 2, a diagrammatic representation of a processing environment 200 is shown, which includes the processor 206, the Processor 208, and a Processor 202 (e.g., a GPU, CPU, or combination thereof).

The Processor 202 is shown to be coupled to a power source 204, and to include (either permanently configured or temporarily instantiated) modules, namely a language model 210, a sensor input 212, a vital sign module 214, a radar ID module 216, and a database 218. The language model 210 operationally generates a output based on sensor data from the sensor input 212 and/or from the vital sign module 214 and/or radar ID module 216 and/or the database 218 and/or other modules that process data from the sensor input 212. The database 218 stores user specific conversation history/context/preferences that can form part of a prompt to the language model 210. The radar ID module 216 determines a person's identity based on backscattered signal 108 as disclosed in U.S. patent application Ser. No. 18/220,439 filed Jul. 11, 2023, which is incorporated by reference. Alternatively, other person identification methods can be used such as facial recognition.

In example, the modules of the processor 202 may be distributed among different processors, servers, locations, etc.

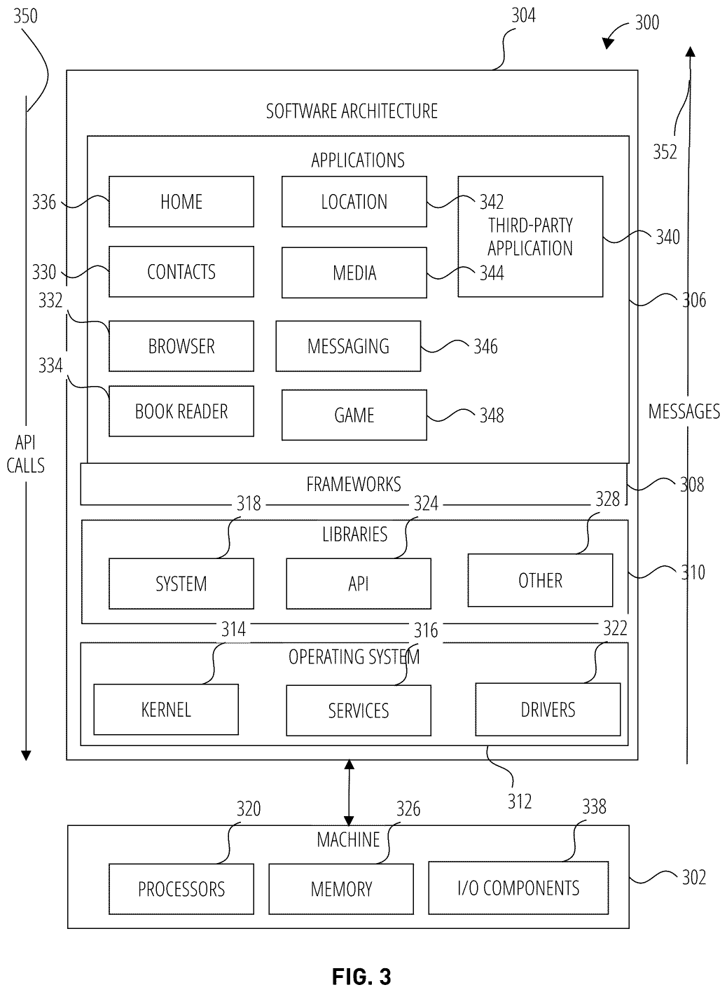

FIG. 3 is a block diagram 300 illustrating a software architecture 304, which can be installed on any one or more of the devices described herein. The software architecture 304 is supported by hardware such as a machine 302 that includes processors 320, memory 326, and I/O components 338. In this example, the software architecture 304 can be conceptualized as a stack of layers, where each layer provides a particular functionality. The software architecture 304 includes layers such as an operating system 312, libraries 310, frameworks 308, and applications 306. Operationally, the applications 306 invoke API calls 350 through the software stack and receive messages 352 in response to the API calls 350.

The operating system 312 manages hardware resources and provides common services. The operating system 312 includes, for example, a kernel 314, services 316, and drivers 322. The kernel 314 acts as an abstraction layer between the hardware and the other software layers. For example, the kernel 314 provides memory management, Processor management (e.g., scheduling), component management, networking, and security settings, among other functionalities. The services 316 can provide other common services for the other software layers. The drivers 322 are responsible for controlling or interfacing with the underlying hardware. For instance, the drivers 322 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, and power management drivers.

The libraries 310 provide a low-level common infrastructure used by the applications 306. The libraries 310 can include system libraries 318 (e.g., C standard library) that provide functions such as memory allocation functions, string manipulation functions, mathematic functions, and the like. In addition, the libraries 310 can include API libraries 324 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., Web Kit to provide web browsing functionality), and the like. The libraries 310 can also include a wide variety of other libraries 328 to provide many other APIs to the applications 306.

The frameworks 308 provide a high-level common infrastructure used by the applications 306. For example, the frameworks 308 provide various graphical user interface (GUI) functions, high-level resource management, and high-level location services. The frameworks 308 can provide a broad spectrum of other APIs that can be used by the applications 306, some of which may be specific to a particular operating system or platform.

In some examples, the applications 306 may include a home application 336, a contacts application 330, a browser application 332, a book reader application 334, a location application 342, a media application 344, a messaging application 346, a game application 348, and a broad assortment of other applications such as a third-party application 340. The applications 306 are programs that execute functions defined in the programs. Various programming languages can be employed to create one or more of the applications 306, structured in a variety of manners, such as object-oriented programming languages (e.g., Objective-C, Java, or C++) or procedural programming languages (e.g., C or assembly language). In a specific example, the third-party application 340 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 340 can invoke the API calls 350 provided by the operating system 312 to facilitate functionality described herein.

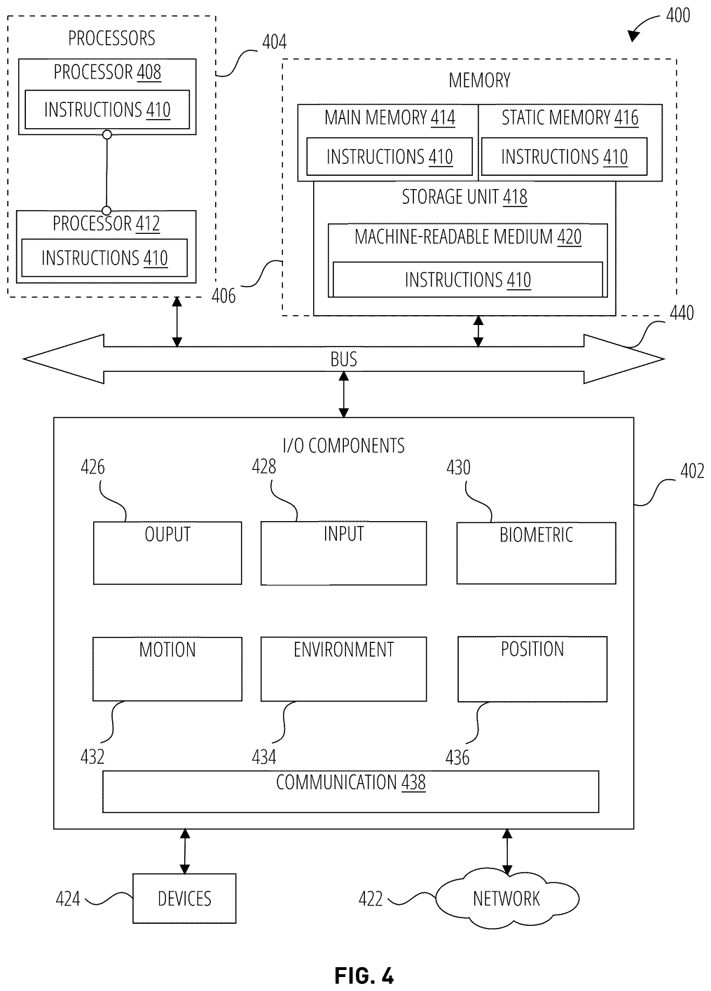

FIG. 4 is a diagrammatic representation of the machine 400 within which instructions 410 (e.g., software, a program, an application, an applet, an app, or other executable code) for causing the machine 400 to perform any one or more of the methodologies discussed herein may be executed. For example, the instructions 410 may cause the machine 400 to execute any one or more of the methods described herein. The instructions 410 transform the general, non-programmed machine 400 into a particular machine 400 programmed to carry out the described and illustrated functions in the manner described. The machine 400 may operate as a standalone device or be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while a single machine 400 is illustrated, the term “machine” may include a collection of machines that individually or jointly execute the instructions 410 to perform any one or more of the methodologies discussed herein.

The machine 400 may include processors 404, memory 406, and I/O components 402, which may be configured to communicate via a bus 440. In some examples, the processors 404 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another Processor, or any suitable combination thereof) may include, for example, a Processor 408 and a Processor 412 that execute the instructions 410. The term “Processor” is intended to include multi-core processors that may comprise two or more independent processors (sometimes referred to as “cores”) that may execute instructions contemporaneously. Although FIG. 4 shows multiple processors 404, the machine 400 may include a single processor with a single core, a single processor with multiple cores (e.g., a multi-core processor), multiple processors with a single core, multiple processors with multiples cores, or any combination thereof.

The memory 406 includes a main memory 414, a static memory 416, and a storage unit 418, both accessible to the processors 404 via the bus 440. The main memory 406, the static memory 416, and storage unit 418 store the instructions 410 embodying any one or more of the methodologies or functions described herein. The instructions 410 may also reside, wholly or partially, within the main memory 414, within the static memory 416, within machine-readable medium 420 within the storage unit 418, within the processors 404 (e.g., within the processor's cache memory), or any suitable combination thereof, during execution thereof by the machine 400.

The I/O components 402 may include various components to receive input, provide output, produce output, transmit information, exchange information, or capture measurements. The specific I/O components 402 included in a particular machine depend on the type of machine. For example, portable machines such as mobile phones may include a touch input device or other such input mechanisms, while a headless server machine will likely not include such a touch input device. The I/O components 402 may include many other components not shown in FIG. 4. In various examples, the I/O components 402 may include output components 426 and input components 428. The output components 426 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), or other signal generators. The input components 428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 402 may include biometric components 430, motion components 432, environmental components 434, or position components 436, among a wide array of other components. For example, the biometric components 430 include components to detect expressions (e.g., hand expressions, facial expressions, vocal expressions, body gestures, or eye-tracking), measure biosignals (e.g., blood pressure, heart rate, body temperature, perspiration, or brain waves), or identify a person (e.g., voice identification, retinal identification, facial identification, fingerprint identification, or electroencephalogram-based identification). The biometric components 430 can include radar to measure a user's vital signs to determine sleep state, wake state, anxiety, etc. The motion components 432 include acceleration sensor components (e.g., accelerometer), gravitation sensor components, rotation sensor components (e.g., gyroscope). The environmental components 434 include, for example, one or cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 436 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 402 further include communication components 438 operable to couple the machine 400 to a network 422 or devices 424 via respective coupling or connections. For example, the communication components 438 may include a network interface Component or another suitable device to interface with the network 422. In further examples, the communication components 438 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 424 may be another machine or any of a wide variety of peripheral devices (e.g., a peripheral device coupled via a USB).

Moreover, the communication components 438 may detect identifiers or include components operable to detect identifiers. For example, the communication components 438 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Data glyph, Maxi Code, PDF417, Ultra Code, UCC RSS-2D bar code, and other optical codes), or acoustic detection components (e.g., microphones to identify tagged audio signals). In addition, a variety of information may be derived via the communication components 438, such as location via Internet Protocol (IP) geolocation, location via Wi-Fi® signal triangulation, or location via detecting an NFC beacon signal that may indicate a particular location.

The various memories (e.g., main memory 414, static memory 416, and/or memory of the processors 404) and/or storage unit 418 may store one or more sets of instructions and data structures (e.g., software) embodying or used by any one or more of the methodologies or functions described herein. These instructions (e.g., the instructions 410), when executed by processors 404, cause various operations to implement the disclosed examples.

The instructions 410 may be transmitted or received over the network 422, using a transmission medium, via a network interface device (e.g., a network interface component included in the communication components 438) and using any one of several well-known transfer protocols (e.g., hypertext transfer protocol (HTTP)). Similarly, the instructions 410 may be transmitted or received using a transmission medium via a coupling (e.g., a peer-to-peer coupling) to the devices 424.

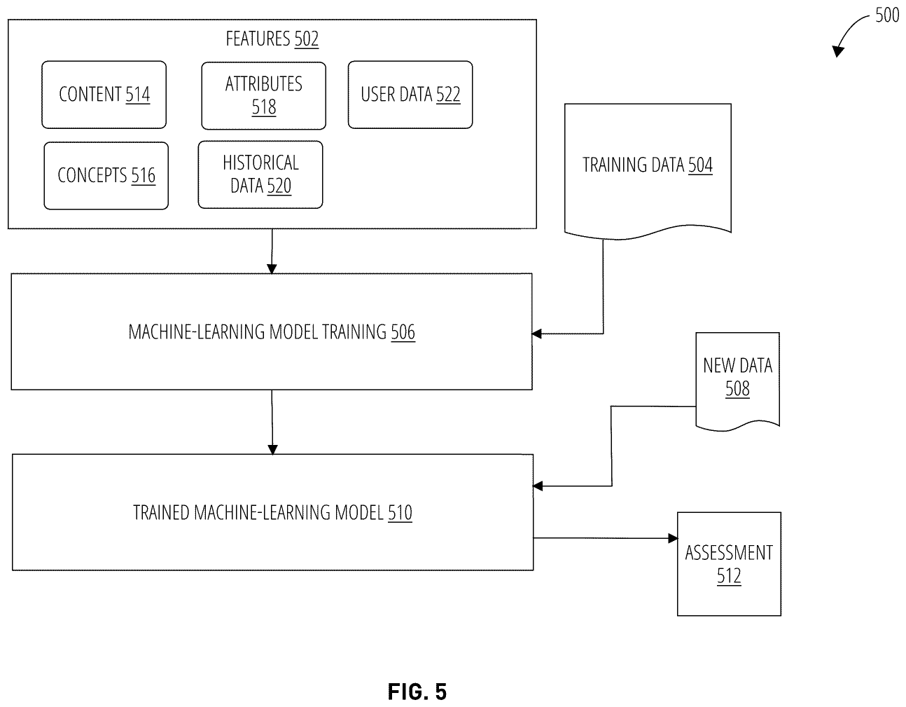

FIG. 5 illustrates training and use of a machine-learning model 500, according to some example embodiments. The machine-learning model 500 can be implemented on the machine 400 as the language model 210. In some example embodiments, machine-learning programs (MLPs), also referred to as machine-learning algorithms, models, or tools, are used to perform operations associated with generating conversations.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 504 in order to make data-driven predictions or decisions expressed as outputs or assessments (e.g., assessment 512). Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine-learning algorithms use features 502 for analyzing the data to generate an assessment 512. Each of the features 502 is an individual measurable property of a phenomenon being observed. The concept of a feature is related to that of an explanatory variable used in statistical techniques such as linear regression. Choosing informative, discriminating, and independent features is important for the effective operation of the MLP in pattern recognition, classification, and regression. Features may be of different types, such as numeric features, strings, and graphs.

In one example embodiment, the features 502 may be of different types and may include one or more of content 514, concepts 516, attributes 518, historical data 520 and/or user data 522, merely for example.

The machine-learning algorithms use the training data 504 to find correlations among the identified features 502 that affect the outcome or assessment 512. In some example embodiments, the training data 504 includes labeled data, which is known data for one or more identified features 502 and one or more outcomes, such as detecting communication patterns, detecting the meaning of the message, generating a summary of a message, detecting action items in messages detecting urgency in the message, detecting a relationship of the user to the sender, calculating score attributes, calculating message scores, etc.

With the training data 504 and the identified features 502, the machine-learning tool is trained at machine-learning model training 506. The machine-learning tool appraises the value of the features 502 as they correlate to the training data 504. The result of the training is the trained machine-learning model 510.

When the trained machine-learning model 510 is used to perform an assessment, new data 508 is provided as an input to the trained machine-learning model 510, and the trained machine-learning model 510 generates the assessment 512 as output.

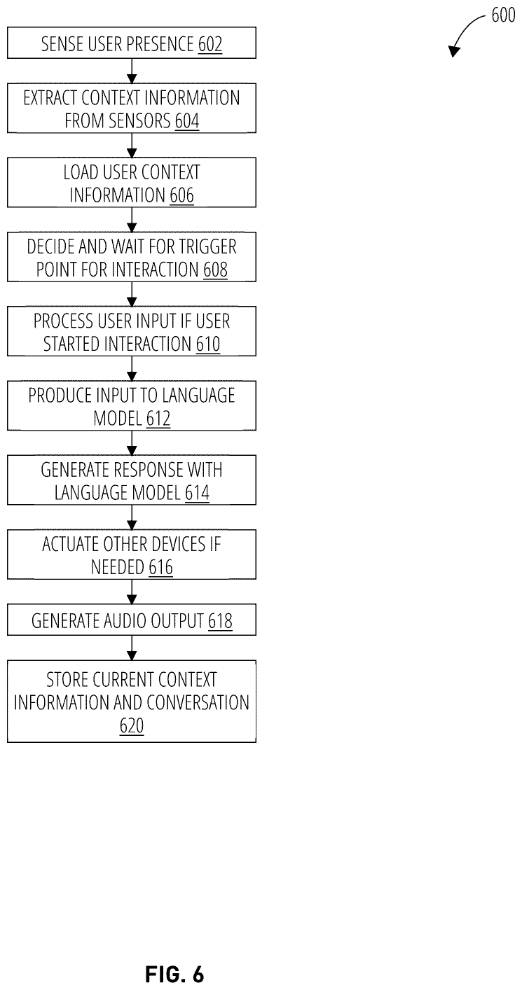

FIG. 6 illustrates a method 600, according to some example embodiments. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

Block 602: Actively sense for user: The device 104 actively senses the environment with the sensor input 212, using the radar, microphone, camera and/or other sensors mentioned above to determine if a user is present.

Block 604: Extract context information from sensors, for example:
1. Basic: temperature, light, time/date, volume/noise level in room
2. User location: locate the user with radar, camera, spatial audio, or motion sensor
3. Determine user activity: e.g. if user is watching TV, user is getting out of bed (using radar, mic, camera)
4. Determine vital signs (e.g., using the vital sign module 214 with a radar sensor to detect vital signs, which can indicate sleep, waking up, anxiety, etc. For example, a trained machine learning model can detect vital signs of a user based on backscattered radar reflections. An elevated heartrate may indicate anxiety.).
5. Determine facial expressions with camera; and/or
6. Determine user mood from audio and/or camera

### (Optional): Identify the User

1. using radar ID (e.g., by training a machine learning model based on radar reflections of persons to identify persons, the model may include a self-supervised similarity model),
2. Gait recognition,
3. Voice id (when they user is speaking to the device)
4. face recognition,

Block 606: Load additional user specific conversation history/context/preferences, based on the context above from the database 218.

Block 608: Identify trigger points for the voice assistant to talk to the user
1. Block 610: The user directly talks to the device 104
2. Wait for specific sensor readings and associated rules to be fulfilled in order trigger an interaction. E.g. the user just came to the room and turned on the light, the user just went to bed, the user just woke up, the user is experiencing anxiety as indicated by vital signs.

Block 612: Identify which sensor and user context information to provide to an AI language model 210. AI language models have a limited capacity for the “prompt context” that they are using for generating language. Decide what subset of sensor and user context information is provided to the language model, based on previous interactions between the user and language model 210, and using the current sensor readings. E.g. if the user's vital signs indicate stress, use context information from previous conversations where the user discussed stress and what caused it, so that the device can have a “targeted” conversation.

Block 612: Integrate selected Sensor Context and User context into the “prompt context” of the AI language model 210.

Block 612: Generate input to the AI language model 210
1. If the trigger point was the user speaking to the device, transcribe speech to text and feed the text to the AI 210. Potentially run additional processing on the transcribed text.
2. If the trigger point was a sensor, generate a transcription of this trigger moment and feed it to the language model 210 (e.g. “the user just entered the room”)

Block 612: As an extension to the previous point, modulate the input by using sensor context, e.g. use the detected vital signs or mood to change the “tone” used by the language model 210 (e.g. “the user looks stressed, use a calming voice or speaking style”)

Block 614: Inference
1. Run the inference on the AI language model 210 to generate a textual response
2. In parallel using a second inference or as part of the same inference, classify the input to determine if a change to the environment is desired or requires, e.g. if the temperature in the room needs to be changed.

Block 616: If in the previous block a request to change the environment was detected, trigger other devices in the home to make this change. This can be achieved e.g. using Matter/Zigbee or similar connectivity technology.

Block 618: Convert the inference result in block 614 from text to speech and play the output to the user

Block 620: Record this interaction between user and device in the database 218.
1. Use a language model to classify the topic of the interaction and store the classification together with the interaction
2. Use another language model to summarize the conversation into key information. This effectively acts as a “compression”. This compressed conversation will help save space in the limited “prompt context” of block 612 above. The summarization will be done in parallel for multiple time-frames: one summary is generated for all conversations that happened in the same hour, one summary per day, one per week, one per month, etc., Each of these summarizations will reduce irrelevant information and extract higher level “ideas”. The reason to use multiple levels is that in block 612 above information from the different levels are used by the device to both have a good amount of short-term information to carry on a conversation while also being able to refer to topics from the past.

Take note of the vital and mood information of the user and record it together with the recorded conversation. This enabled the device to create a feedback loop of interventions and the effect they had. This information will be integrated into block 606 as additional context to let the device measure if the response generated by the Voice Assistant has the desired effect.

The device is using it's sensors to determine if the user is present or if there's a significant change in what they are doing-something that is worth acknowledging by the device to drive behavior or initiate conversations.

An example is the user going to sleep-which technically means the user entering the room, going to bed and lying down. The device will use this trigger point to determine of the moment of going to bed is in line with the pre-determined schedule for the user. If not, the device will start a conversation with the user to understand why they are going to bed too early of too late and through the conversation get them to do stick to their prescribed routine.

Other trigger points for conversations are e.g. the user entering the room, the user waking up, the user being awake in bed and trying to sleep, augmented with sleep quality indicators.

Conversations include the ability for the device to extract “interests and hobbies” from the user's responses through machine learning approaches-we use text classification to determine if the current conversation is about interest and hobbies and then look for these in the text. E.g. if the user mentions they like yoga, it will remember this and use it again during future conversations—for the user it will appear that the device got to know them better over time and leads more relevant conversations.

In addition, the device uses the concept of a short-term and long-term memory to make conversations better. It uses all information about what was recently discussed but for conversations that happened in the past, it uses AI language technology to summarize all past conversations for a given timeframe to a much smaller body of text. E.g. all conversations for a given day are boiled down to a couple of key ideas-comparable almost to a diary. The same happens for the conversations that happened in the same week, month or other time periods. These summarized conversations are also used by the device as additional “context” when leading new conversations.

The ability to hold many information in the limited context of the device is crucial, since the user is not necessarily asking specific questions that allow the device to use conventional information retrieval from a database (e.g. find the 10 most relevant documents that answer the question). Instead, the proactive nature enables the device to have a body of information available before the user is even asking for it. For example, if the user states they can't sleep because they have racing thoughts, the device will draw from the context in it's long-term compressed memory to come up with strategies to try, based on preferences and knowledge mentioned by the user in the past.

### EXAMPLES

1. A method, comprising:
sensing, with a sensor, a user;
extracting information from the sensor;
providing a language model with the extracted information upon determining a trigger point has been reached; and
generating, with the language model, a response to the extracted information.

2. The method of example 1, wherein the sensor includes a radar and the extracted information includes vital signs.

3. The method of any of the preceding examples, wherein the trigger point includes a user talking.

4. The method of any of the preceding examples, further comprising providing a transcription of the user talking to the language model with the extracted information.

5. The method of any of the preceding examples, wherein the trigger point includes a user action.

6. The method of any of the preceding examples, wherein the trigger point includes a change in environmental measurements.

7. The method of any of the preceding examples, wherein the sensor includes a radar and the method further comprises:
identifying the user with the radar; and
providing, to the language model, user-specific context based on the identity of the user with the extracted information.

8. The method of any of the preceding examples, wherein the user-specific context includes one or more of conversation history, context and preferences.

9. The method of any of the preceding examples, wherein the extracted information includes one or more of environmental data, user location, user activity, vital signs, facial expressions and user mood.

10. A non-transitory computer-readable storage medium, the computer-readable storage medium including instructions that when executed by a computer, cause the computer to:
sense, with a sensor, a user;
extract information from the sensor;
provide a language model with the extracted information upon determining a trigger point has been reached; and
generate, with the language model, a response to the extracted information.

11. A system, comprising:
a processor; and
a non-transitory memory storing instructions that, when executed by the processor, configure the system to:
sense, with a sensor, a user;
extract information from the sensor;
provide a language model with the extracted information upon determining a trigger point has been reached; and
generate, with the language model, a response to the extracted information.

12. The system of example 11, wherein the sensor includes a radar and the extracted information includes vital signs.

13. The system of any of the preceding examples, wherein the trigger point includes a user talking.

14. The system of any of the preceding examples, wherein the instructions further configure the apparatus to provide a transcription of the user talking to the language model with the extracted information.

15. The system of any of the preceding examples, wherein the trigger point includes a user action.

16. The system of any of the preceding examples, wherein the trigger point includes a change in environmental measurements.

17. The system of any of the preceding examples, wherein the sensor includes a radar and wherein the non-transitory memory further stores instructions that, when executed by the processor, further configure the system to:
identify the user with the radar; and
provide, to the language model, user-specific context based on the identity of the user with the extracted information.

18. The system of any of the preceding examples, wherein the user-specific context includes one or more of conversation history, context and preferences.

19. The system of any of the preceding examples, wherein the extracted information includes one or more of environmental data, user location, user activity, vital signs, facial expressions and user mood.

20. The system of any of the preceding examples, wherein the trigger point includes the user entering a room.

### Example 21

Users have natural voice conversations with the device 104. The device 104 has a lot of context and data about the user, e.g., current and past sleep data, when they are inside/outside the bed/bedroom, what they do in the mobile app, and uses that for answering questions that the user might have.

### Example 22

If appropriate, the device 104 also starts conversations proactively without the user prompting for it. E.g. when the user goes to bed too early, the device will start a conversation around that, asking the user why they go to bed earlier than usual. Depending on the response, it might draw the user into a conversation to keep them awake longer and let them adhere to the sleep schedule.

### Example 23

Another example is that the device 104 uses AI Language technology to generate wind-down stories. If the user is in bed and can't sleep, the user can just ask the device 104 “to make up” a story. The story is generated using AI language models. The user can specify the topic and if none is given, the device 104 uses all context information available to it (for example: current time, sleep information, how long has the user been in bed, previously learned user interests). The device 104 can also proactively offer a story when the user appears not to be able to sleep or is not yet supposed to sleep (based on their sleep schedule.

### Example 24

Integration with other IoT devices. I.e. if the user in a conversation with the device complains that they can't sleep, the device would e.g. measure the room temperature and suggest to lower the temperature and if the user agrees in the conversation then it would actually trigger this.

### Example 25

Another use-case is using sensing of vital signs to determine anxiety While a user is having a conversation, the device 104 can ask the user to do some relaxation technique or exercise and determining the effect it has on them live etc.

### Example 26

People who struggle from depression often need help with motivation to get out of bed. The device 104 recognizes this, and automatically initiates a conversation in the morning about things to do during the day, and things/activities to look forward to.

### Example 27

Medication Adherence. The language model 210 maintains a list of medication schedules, and the device 104 initiates a conversation to remind the user about their medicines at the appropriate times.

What is claimed is:

1. A method, comprising:
sensing, with a sensor, a user;
extracting information from the sensor;
providing a language model with the extracted information upon determining a trigger point has been reached; and
generating, with the language model, a response to the extracted information.

2. The method of claim 1, wherein the sensor includes a radar and the extracted information includes vital signs.

3. The method of claim 1, wherein the trigger point includes a user talking.

4. The method of claim 3, further comprising providing a transcription of the user talking to the language model with the extracted information.

5. The method of claim 1, wherein the trigger point includes a user action.

6. The method of claim 1, wherein the trigger point includes a change in environmental measurements.

7. The method of claim 1, wherein the sensor includes a radar and the method further comprises:
identifying the user with the radar; and
providing, to the language model, user-specific context based on the identity of the user with the extracted information.

8. The method of claim 7, wherein the user-specific context includes one or more of conversation history, context and preferences.

9. The method of claim 1, wherein the extracted information includes one or more of environmental data, user location, user activity, vital signs, facial expressions and user mood.

10. A non-transitory computer-readable storage medium, the computer-readable storage medium including instructions that when executed by a computer, cause the computer to:
sense, with a sensor, a user;
extract information from the sensor;
provide a language model with the extracted information upon determining a trigger point has been reached; and
generate, with the language model, a response to the extracted information.

11. A system, comprising:
a processor; and
a non-transitory memory storing instructions that, when executed by the processor, configure the system to:
sense, with a sensor, a user;
extract information from the sensor;
provide a language model with the extracted information upon determining a trigger point has been reached; and
generate, with the language model, a response to the extracted information.

12. The system of claim 11, wherein the sensor includes a radar and the extracted information includes vital signs.

13. The system of claim 11, wherein the trigger point includes a user talking.

14. The system of claim 13, wherein the instructions further configure the apparatus to provide a transcription of the user talking to the language model with the extracted information.

15. The system of claim 11, wherein the trigger point includes a user action.

16. The system of claim 11, wherein the trigger point includes a change in environmental measurements.

17. The system of claim 11, wherein the sensor includes a radar and wherein the non-transitory memory further stores instructions that, when executed by the processor, further configure the system to:
identify the user with the radar; and
provide, to the language model, user-specific context based on the identity of the user with the extracted information.

18. The system of claim 17, wherein the user-specific context includes one or more of conversation history, context and preferences.

19. The system of claim 11, wherein the extracted information includes one or more of environmental data, user location, user activity, vital signs, facial expressions and user mood.

20. The system of claim 11, wherein the trigger point includes the user entering a room.
